(19) United States
(12) Patent Application Publication
(10) Pub. No.: US 2010/0092274 A1
(43) Pub. Date: Apr. 15, 2010

(54) TRANSPORT SYSTEM

(75) Inventors: Fabian RUDNER, Ravensburg (DE); Arthur HALDER, Ostrach (DE)

Correspondence Address: CARTER, DELUCA, FARRELL & SCHMIDT, LLP, 445 BROAD HOLLOW ROAD, SUITE 420, MELVILLE, NY, 11747, US

(73) Assignee: LIEBHERR-MISCHTECHNIK GMBH, Bad Schussenried (DE)

(21) Appl. No.: 12/576,568

(22) Filed: Oct. 9, 2009

(30) Foreign Application Priority Data
Oct. 10, 2008 (DE) 10 2008 051 162.5

(51) Int. Cl. B65G 21/10; F16M 13/00; B23P 6/00

(52) U.S. Cl. 414/744.2; 248/351; 29/402.01

(57) ABSTRACT

The present invention shows a transport system for the transport of bulk goods, in particular of concrete, comprising a transport belt for the conveying of the bulk goods to an unloading point, wherein a rotary arm is provided which is rotatable about a vertical axis of rotation and which transports bulk goods to its free end and unloads them there. In this respect, the rotary arm is supported at a holder which is or can be arranged at a stationary support column such that the axis of rotation of the rotary arm extends eccentrically to the support column, with the rotary arm advantageously being arranged next to the support column, viewed from above, in at least one rotational position. The invention furthermore shows a corresponding support column as well as a method for the rebuilding of the transport system.

The present invention relates to a transport system for the transport of bulk goods, in particular of liquid or semi-liquid bulk goods, in particular of concrete, having a transport belt for the conveying of the bulk goods to an unloading point, with a rotary arm being provided which is rotatable about a vertical axis of rotation and which transports the bulk goods to its free end and unloads it there.

Such transport systems are in particular used on large construction sites such as dams at which large quantities of concrete are required. It is then usually prepared in a central mixer and is transported from there via the transport system to the respective unloading point. The rotary arm of the transport system in this respect provides that the concrete can be distributed over a larger area.

As construction work progresses, however, the transport system has to be adapted to the changing construction site and the unloading point has to be moved to a different position from time to time. For this purpose, the rotary arm in some known systems is mounted on a mobile piece of working equipment to increase the radius of the transport system. If, in contrast, the rotary arm is mounted on a stationary support column, the rotary arm has to be dismantled for the rebuilding of the transport system and has to be mounted on another stationary support column again. This is frequently laborious and associated with high costs with known transport systems.

It is the object of the present invention to provide a transport system for the transport of bulk goods, in particular of concrete, which can be rebuilt simply.

In accordance with the invention, this object is satisfied by a transport system in accordance with claim 1. In the transport system in accordance with the invention of bulk goods, in particular of concrete, having a transport belt for the conveying of the bulk goods to an unloading point, a rotary arm is provided in this respect which is rotatable about a vertical axis of rotation and which transports bulk goods to its free end and unloads them there. In accordance with the invention, the rotary arm is supported in this respect at a holder which is or can be arranged at a stationary support column such that the axis of rotation of the rotary arm extends eccentrically to the support column. The rotary arm is in this respect, viewed from above, advantageously arranged to the side next to the support column in at least one rotary position. The assembly and dismantling of the rotary arm at the support column is substantially simplified by the eccentric or lateral arrangement of the rotary arm next to the support column on a corresponding holder. The eccentric or lateral arrangement of the rotary arm in accordance with the invention furthermore allows a good rotatability of the rotary arm about its vertical axis of rotation.

The rotary arm in accordance with the invention in this respect advantageously has a transport belt which receives bulk goods from a further transport belt in the region of the axis of rotation and transports it to the free end of the rotary arm. An unloading apparatus is advantageously provided there via which the bulk goods can be loaded e.g. onto a truck. The unloading apparatus can in this respect e.g. include a vertically extending hose. Further advantageously, the rotary arm includes a counterweight on the side opposite the unloading apparatus. The supporting construction of the rotary arm is in this respect advantageously made as a lattice construction and is furthermore advantageously assembled from lattice pieces.

The rotary arm is advantageously arranged in a rotary union which is supported on the holder via a first rotating assembly and which carries an end of a belt bridge via a second rotating assembly, said belt bridge transporting the bulk goods to the rotary arm. The rotary arm can hereby be rotated via the first rotary assembly with respect to the support column, but also via the second rotary assembly with respect to the belt bridge via which the bulk goods are transported to the rotary arm. The belt bridge is in this respect advantageously made as a lattice construction in which a transport belt is provided for the conveying of the bulk goods. The transport belt in this respect advantageously ends above the rotary union through which the rotary arm is guided so that the bulk goods drops from the transport belt of the belt bridge onto the transport belt of the rotary arm. The belt bridge can in this respect be arranged in a stationary manner by the rotary union, while the rotary arm also remains rotatable with respect to the belt bridge.

The holder is or can be advantageously arranged in this respect in accordance with the invention at the stationary support column such that the rotary arm is arranged higher than the upper end of the support column so that it can be rotated over the support column. For this purpose, the rotary union can e.g. be arranged higher than the upper end of the support column. This arrangement allows a rotatability of the rotary arm through 360°. If, however, the belt bridge arranged above the rotary arm extends at a certain angle to the horizontal, this can restrict the rotatability of the rotary arm somewhat so that a rotary angle of e.g. approximately 300° results.

If, in contrast, the holder is arranged at the support column such that the rotary arm cannot be pivoted over the upper end of the support column, a much smaller rotational range results, with the maximum angle of rotation depending on the spacing of the rotary arm from the support column. The angle of rotation is, however, also then advantageously greater than 50°.

Advantageously, in accordance with the invention, the support column is made up of a plurality of elements, in particular of a plurality of lattice elements, so that the height of the support column can be increased by placing on further elements. Such a design of the support column from a plurality of elements allows a flexible adaptation of the height of the support column. The support column is in this respect advantageously made up of lattice pieces such as are used for the tower of tower cranes.

Advantageously, in accordance with the invention, at least one element can furthermore be placed onto the support column without dismantling the holder and/or the rotary arm. Since a further element, in particular a lattice element, can be placed onto the upper end of the rotary arm without the holder or the rotary arm having to be dismantled for this purpose, the height of the support column can also be changed with a mounted rotary arm. This permits a substantially more flexible rebuilding of the transport system in accordance with the invention. In this respect, the element placed onto the upper end of the support columned can in particular be used for the rebuilding or dismantling of the rotary arm.

The transport system in accordance with the invention can include still further elements which extend the transport path.

The transport system in accordance with the invention in this respect advantageously includes a second support column at which a second holder is arranged, with the holder bearing the ends of two belt bridges. In this respect, the second support column is also advantageously stationary. Further advantageously, the ends of the two belt bridges are in this respect arranged via the holder to the side next to the support column, viewed from above. Two belt bridges can thus be connected to one another via the second holder, said belt brides being equipped with transport belts for the transport of the bulk goods, with the bulk goods being redirected from one transport belt to the other. The operating range of the transport system in accordance with the invention can thus be extended by the second support column with the corresponding holder and the two belt bridges. In this respect, the operating range can in particular be extended by the use of a plurality of support columns and optionally a plurality of belt bridges.

In this respect, the one belt bridge is advantageously arranged in a rotary union on the second holder so that this belt bridge is rotatable about a vertical axis of rotation with respect to the second holder and/or the other belt bridge. For instance, the belt bridge can e.g. be rotated and can be mounted at its other end to another stationary support column to transport the bulk goods to another position without the second holder or the other belt bridge having to be dismantled.

In this respect, the second holder for the belt bridges is advantageously of the same construction as the holder for the rotary arm. The holder can hereby be used flexibly either for rotary arms or belt bridges. The matching to the respective application then advantageously takes place via a corresponding rotary union which is adapted either to the rotary arm or to a belt bridge.

Further advantageously, the transport system in accordance with the invention includes a lifting apparatus for the lifting of the rotary arm and/or of the belt bridge. The rotary arm and/or the belt bridge can be raised by this lifting apparatus to rebuild the transport system in accordance with the invention.

Advantageously, in this respect, the lifting apparatus can be arranged at a support column, in particular at an element of the support column which can be placed onto the upper end of the support column for this purpose. The holder of the rotary arm or of the belt bridge can hereby be arranged at the support column in normal operation such that the rotary arm or the belt bridge is rotatable beyond the support column. For the rebuilding, a further element can then be placed onto the support column at which the lifting apparatus is arranged to lift the rotary arm or the belt bridge.

Further advantageously, in accordance with the invention, the holder of the rotary arm or of the belt bridge can be mounted at different heights to the stationary support column. This is advantageously a steel construction which includes the support column and has a platform for the mounting of the rotary arm or of the belt bridge next to the support column. The platform is in this respect advantageously supported via an obliquely extending support arm with respect to the support column.

The present invention furthermore includes a support column for a transport system for the transport of bulk goods, in particular of concrete, for the support of at least one belt bridge and/or of at least on rotary arm, with the support column having a holder for the belt bridge and/or for the rotary arm which is mounted to the support column such that the belt bridge and/or the rotary arm are arranged next to the support column, viewed from above, with the belt bridge and/or the rotary arm being arranged higher than the upper end of the support column. In this respect, the support column can be extended in length by a further element which can be mounted at the upper end of the support column.

It is hereby possible to rotate the belt bridge or the rotary arm beyond the upper end of the support column in normal operation such that a large range results in which the rotary arm or the belt bridge can be rotated. The support column can, however, be extended beyond the holder by the further element which can be mounted at the upper end of the support column, e.g. in order to facilitate the assembly or dismantling of the rotary arm or of the belt bridge or to increase the height of the support column. The fact that the rotary arm or the belt bridge are arranged next to the support column, viewed from above, in this respect allows the mounting of the further element at the upper end of the support column without the holder or the belt bridge or the rotary arm already having to be dismantled for this purpose.

Further advantageously, the support column in accordance with the invention is a support column for a transport system such as was described further above.

The present invention furthermore includes a method for the rebuilding of a transport system for the transport of bulk goods, in particular of concrete, having a belt bridge and/or a rotary arm with a transport belt for the conveying of the bulk goods, with the belt bridge and/or the rotary arm being arranged next to the support column and with the lifting of the belt bridge and/or of the rotary arm taking place via a lifting device arranged at the support column above the belt bridge and/or the rotary arm. Due to the lateral arrangement of the belt bridge or of the rotary arm, they can be raised without problem via the lifting device. This e.g. allows the assembly or dismantling of another rotary joint or the mounting of the holder at a different height.

Advantageously, in this respect, at least one element, in particular a lattice element, is placed onto the support column for the lifting of the belt bridge and/or of the rotary arm to extend said support column in length beyond the holder, with the lifting device being arranged at said element. The rotary arm or belt bridge can hereby be pivoted beyond the support column in normal operation. For the rebuilding of the transport system in accordance with the invention, in contrast, the support column can be extended by the at least one further element to be able to arranged the lifting device at the support column above the rotary arm or the belt bridge. A particularly flexible embodiment of the rebuilding of the transport system in accordance with the invention thereby results so that e.g. the rotary arm can be moved from one support column to another support column or the height of the arrangement of the rotary arm or of the belt bridge at the support column can be changed in that e.g. the holder is dismantled and is assembled again at a different height at the support column.

Further advantageously, the element to which the lifting device was mounted is dismantled again after the rebuilding of the transport system. The full rotatability of the rotary arm or of the belt bridge is hereby again established.

Advantageously, in accordance with the invention, in this respect a rotary union is mounted, dismantled and/or replaced after the lifting of the belt bridge and/or of the rotary arm, whereupon the belt bridge and/or the rotary arm is lowered again.

Advantageously, the method in accordance with the invention for the rebuilding of a transport system is in this respect used for the rebuilding of a transport system such as was described further above.

The present invention will now be described in more detail with reference to embodiments and drawings. There are shown:

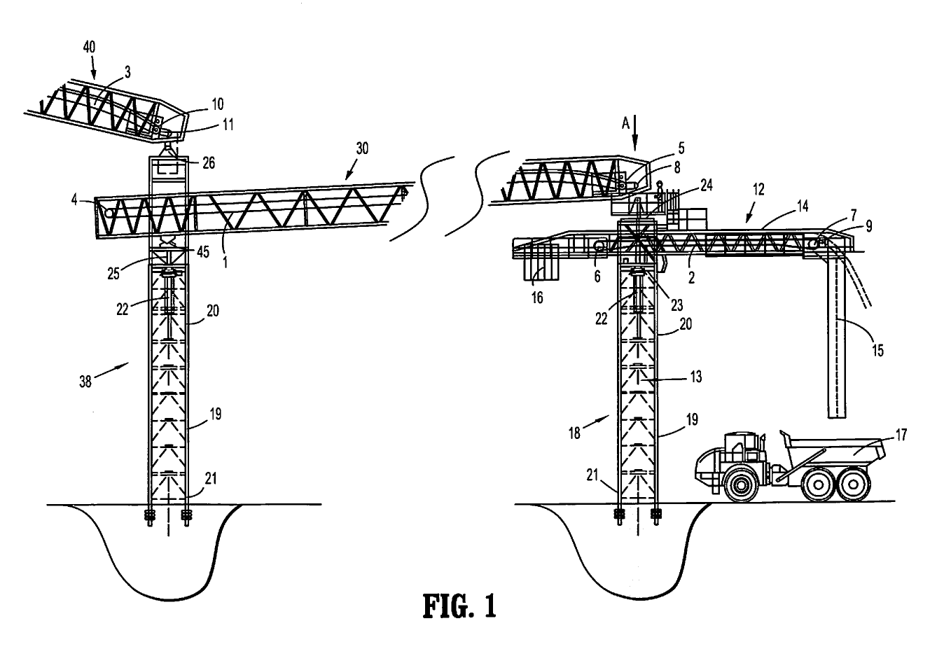

FIG. 1: an embodiment of the transport system in accordance with the invention with an embodiment of a support column in accordance with the invention in a side view;

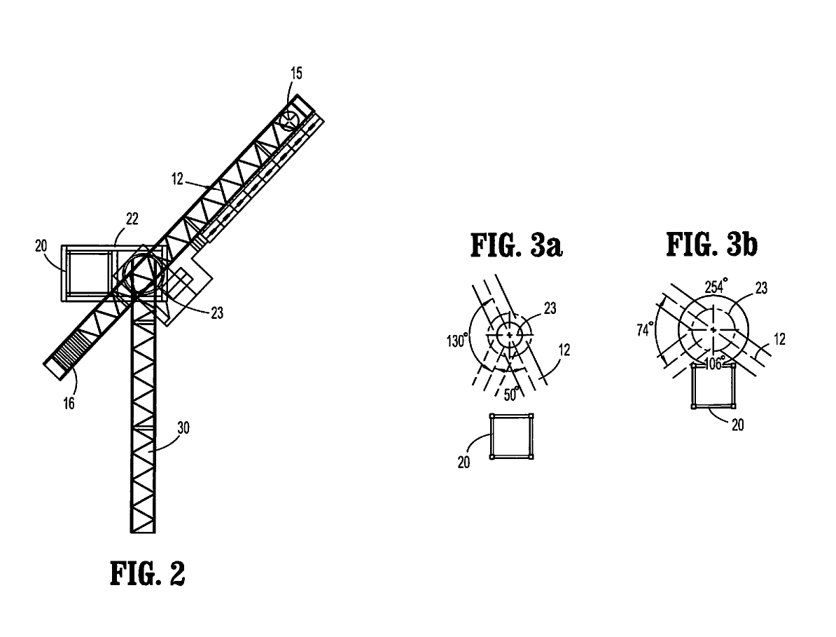

FIG. 2: the embodiment of the transport system in accordance with the invention in a plan view;

FIGS. 3a, 3b: the rotary angles of the rotary arm for alternative embodiments of the transport system in accordance with the invention;

FIG. 4a: a further side view of a part of the transport system in accordance with the invention;

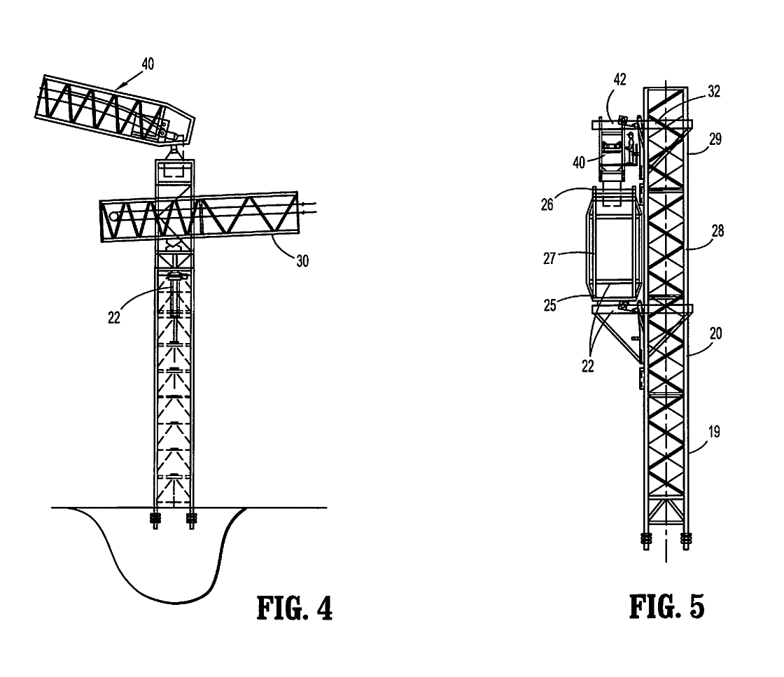

FIG. 5a: a side view of a transport system in accordance with the invention for the illustration of an embodiment of the method in accordance with the invention for the rebuilding of the transport system;

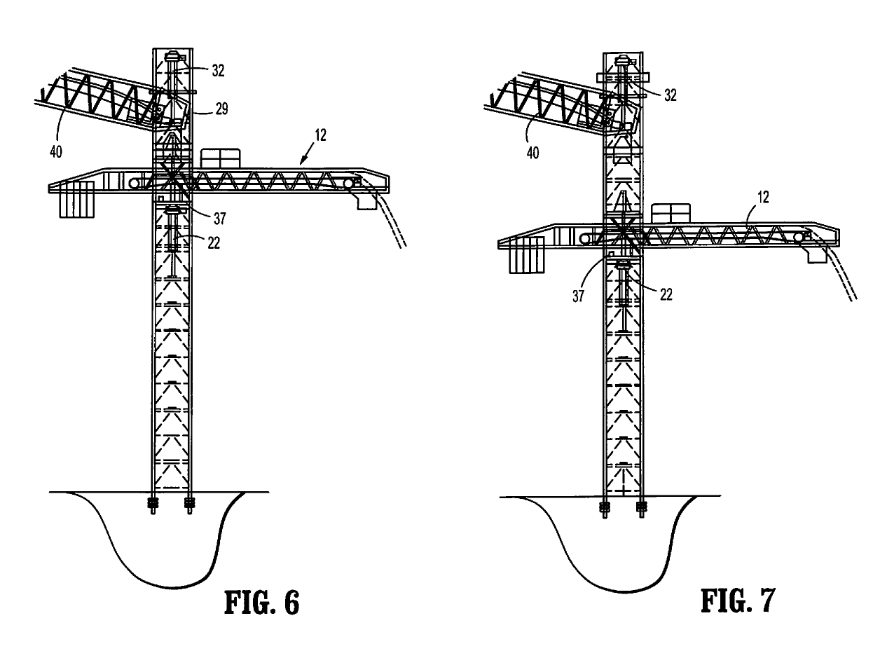

FIGS. 6, 7: two further side views of the transport system in accordance with the invention for the illustration of the method in accordance with the invention;

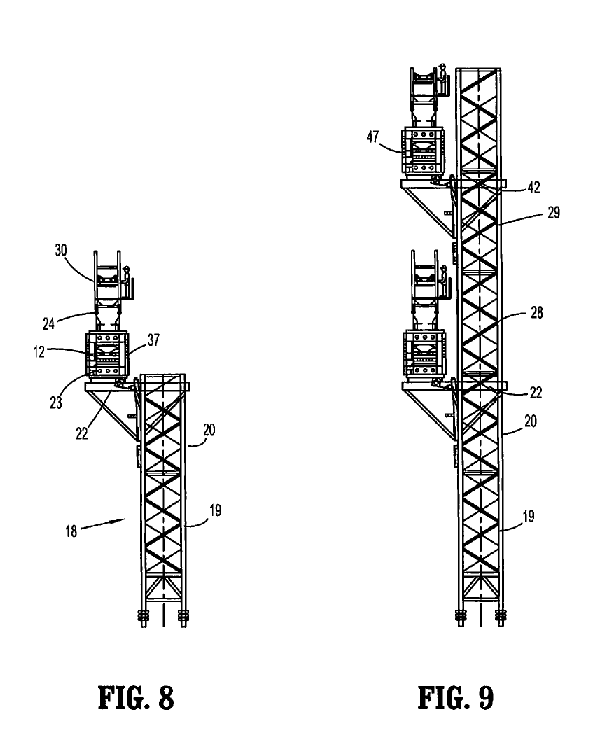

FIG. 8a: a sectional view through the embodiment of the transport system in accordance with the invention; and

FIG. 9: a sectional view through a further embodiment of the transport system in accordance with the invention.

FIG. 1 shows an embodiment of a transport system in accordance with the invention for the transport of bulk goods. The transport system in accordance with the invention in this respect serves for the transport of concrete, in particular of liquid or semi-liquid concrete at a construction site. In this respect, the concrete is transported over long distances e.g. on the construction of dams to transport it from a mixing plant where the concrete is made to an unloading point. For this purpose, the transport system has transport belts 1, 2 and 3 via which the concrete is transported to an unloading point. The transport belts 1 and 3 are in this respect arranged in belt bridges 30 and 40 and run over rollers 4 and 5 or 10 in an endless manner. The transport belts 1 and 3 are in this respect driven via motors 8 and 11.

The belt bridges 30 and 40 are supported via two stationary support columns 18 and 38. The concrete is in this respect transported via the belt bridge 40 to the support column 38 where it runs onto the belt bridge 30 which transports the concrete in turn to the support column 18. A rotary arm 12 which is rotatable about a vertical axis of rotation 13 is provided as the support column 18 in this respect. A further transport belt 2 is provided in the rotary arm 12 and the concrete is transported via it to the free end of the rotary arm and is unloaded there via an unloading apparatus 15. The transport belt 2 of the rotary arm 12 in this respect runs over rollers 6 and 7 in an endless manner and is driven via a motor 9. The rotary arm 12 has a counterweight 16 on the side disposed opposite the unloading side.

In accordance with the invention, the rotary arm 12 is arranged in this respect via a holder 22 at the support column 18 so that its axis of rotation extends eccentrically to the support column. In this respect, the rotary arm 12 is arranged in a certain rotational region next to the support column 18, viewed from above. For this purpose, the holder 22 on which the rotary arm 12 is supported is arranged laterally at the stationary support column 18. The eccentric or lateral arrangement of the rotary arm 12 with respect to the support column 18 produces advantages with respect to the rotatability of the rotary arm 12 as well as with respect to the rebuilding of the transport system.

Since the unloading of concrete should not always take place at a single unloading point at large construction sites such as dams, but rather a high flexibility is required with respect to the unloading point, the good rotatability of the rotary arm and the simple rebuilding of the transport system provides substantial advantages. By rotating the rotary arm 12, the position of the unloading apparatus 15, which here comprises a vertically extending hose which extends from the rotary arm downward up to and into a certain unloading level, can be changed without problem in this respect. The concrete can hereby be unloaded at different points in the region of the angle of rotation of the rotary arm, e.g. to load a transport vehicle 17.

To ensure the rotatability of the rotary arm 12, it is arranged in a rotary union 37 which is supported on the holder via a first rotating assembly 23 and bears the belt bridge 30 via a second rotating assembly 24 so that the rotary arm 12 is rotatable both with respect to the stationary support column 18 and with respect to the stationary belt bridge 30.

The holder 22 is in this respect arranged at the support column 18 such that the rotary arm is arranged higher than the upper end of the support column 18 so that it can be rotated beyond the support column. An angle of rotation of 360° of the rotary arm hereby results with respect to the support column 18. The angle of rotation of the rotary arm 12 can be restricted in this respect at most by the obliquely extending belt bridge 30, with an angle of engagement of 15° of the belt bridge 30 being a restriction of the angle of rotation of the rotary arm 12 to 300°.

The support column 18 and equally the support column 38 is in this respect made up of a plurality of lattice elements so that the height of the support column can be changed by use of a different number of lattice elements. The support columns 18 and 38 in this respect comprise a foot part 21 which serves as a foundation of the support column and is let into the base or into the concrete. Lattice elements 19 and 20 which form the support column are arranged thereon. In this respect, the holder 22 is arranged at the upper lattice element 20 and bears the rotary arm 12 and the belt bridge 30. The belt bridges 30 and 40 as well as the rotary arm are also each assembled from lattice elements. The connection of the individual lattice elements takes place by bolt connections in this respect.

The rotatability of the rotary arm 12 can in this respect again be recognized from FIG. 2 which shows the transport system in accordance with the invention in a top view. The holder 22 is in this respect arranged at the upper lattice element 20 of the support column 18 and surrounds them with a fastening arm. The holder 22 in this respect has a platform which is arranged next to the support column and which bears the rotary arm 12. The rotary arm 12 is in this respect rotatable via a rotating assembly 23 with respect to the holder and thus with respect to the stationary support column. As can likewise be seen from FIG. 2, in this respect the rotating assembly 23 is located outside the base area of the support column so that at least one position of the rotary arm 12 is present in which the rotary arm does not overlap the base surface of the support column. In this respect, the holder 22 is arranged at the support column 18 such that the rotary arm is above the upper end of the support column 18 and can thus be rotated through 360°. An oblique setting of the belt bridge 30 can at best slightly restrict the angle of rotation.

In FIGS. 3a and 3b, in contrast, the possible angles of rotation of the rotary arm 12 are shown when the support column does not end beneath the rotary arm and thus bounds the rotation range of the rotary arm 12. In this respect, a situation is shown in FIG. 3a such as is present with a rotating assembly 21 arranged very far away from the support column 20, which results in a maximum angle of rotation of approximately 130°. In FIG. 3b, in contrast, a situation is shown such as is present in the present invention when a further lattice element is placed onto the lattice piece 20 so that the support column 18 restricts the angle of rotation of the rotary arm 12. A maximum angle of rotation of the rotary arm 12 of approximately 75° results in this respect.

Since the rotary arm is arranged next to the support column, viewed from above, in at least one rotational position, a further element can be placed onto the support column 18 without having to dismantle the holder 22 or the rotary arm 12. This can in particular be of great advantage for the rebuilding of the transport system or for the application of further elements to the support arm.

The same statements with respect to the rotatability and to the simplification of the rebuilding also apply in this respect to the stationary support column 38 which bears the belt bridges 30 and 40 via a holder 22. As can be seen from FIG. 1 and FIG. 4, the support column 38 in this respect has the same structure as the support column 18, with the holder 22 which bears the belt bridge 30 and the belt bridge 40 being arranged at the upper lattice element 20. The two belt bridges are in this respect in turn arranged next to the support column, viewed from above, in at least one position. In this respect, a first rotating assembly 25 is provided via which the belt bridge 30 is supported on the holder 22 and is rotatable with respect to this and to the support column 38. A second rotating assembly 26 is furthermore provided via which the belt bridge 40 is supported so that the belt bridge 30 is also rotatable with respect to the belt bridge 40. A rotary union 27 is provided for this purpose through which the belt bridge 30 passes and which is supported on the holder 22 via the first rotating assembly 25 and on which the belt bridge 40 is supported via the second rotating assembly 26. It is e.g. possible by the rotatable support of the belt bridge 30 to transfer it from the support column 18 to a further support column, not shown, without for this purpose dismantling the apparatus mounted on the support column 28. For this purpose, the belt bridge 30 is supported displaceably on rollers 45 in the rotary union 27. The belt bridge 30 can hereby also be placed on support columns which do not have the same spacing from the support column 38 as the support column 18.

The belt bridge 30 can, however, also be dismantled from the support column 38, e.g. to mount the rotary arm 12 there, as will now be shown with reference to FIGS. 5 to 7. In this respect, further lattice elements 28 and 29 are first mounted onto the upper end of the support column 38, that is onto the lattice element 20, to extend the support column 38 upward beyond the holder 22. This extension of the support column 38 is possible without problem by the lateral arrangement of the belt bridges 30 and 40 on the holder 22. A further holder 32 is mounted at the support column above the belt bridge 40. The holder 32 in this respect bears a lifting apparatus 42 via which the belt bridge 40 is lifted. The belt bridge 30 can now be removed and the rotary union 27 can be dismantled. After the dismantling of the rotary union 27, the differently designed rotary union 37 for the rotary arm 12 is mounted on the holder 22, as is shown in FIG. 7. The belt bridge 40 can thereupon be lowered via the lifting apparatus and can be placed down on the rotating assembly 24 of the rotary union 27 of the rotary arm 12. Alternatively, as is shown in FIG. 6, the holder 22 can also be raised and can be mounted to the support column in an elevated position.

The additional support elements 28 and 29 which are arranged above the holder 22 are advantageously removed again after the rebuilding of the transport system to again ensure the complete rotatability of the rotary arm 12 or of the belt bridge 30.

The reversal of the rebuilding then takes place in reverse manner, with the belt bridge 40 in turn being raised and the rotary union 37 of the rotary arm being replaced by the rotary union 27 of the belt bridge 30.

The arrangement of the rotary arm 12 at the support column 18 is now shown again in FIG. 8. In this respect, the holder 22 is arranged at the upper lattice element 20 of the support column 18 such that the rotary arm is above the upper edge of the support column 18 and can be rotated beyond it. To ensure the rotatability of the rotary arm 12, the rotary arm 12 is arranged in the rotary union 37 which is arranged above the rotating assembly 23 on the holder 22 next to the support column 18. In this respect, a further rotating assembly 24 is provided on the rotary union 37 and bears the belt bridge 30. The belt bridge is thus rotatably supported via the rotary union 37 on the holder 22 and thus on the support column 18.

Since the rotary arm is supported next to the support column 18, further lattice elements can be built on them which project beyond the holder 22 as well as the rotary arm 12 and the belt bridge 30. This is shown in FIG. 9 in which lattice elements 28 and 29 were mounted on the support column 18. In this respect, a further holder 42 which bears a further rotary union 47 with a further rotary arm is fastened to the lattice element 29 above the rotary arm 12. More complicated transport systems can hereby also be realized. A holder 22 for the rotary arm or for one or more belt bridges can also be mounted at different heights on the support column. For this purpose, the holder 22 is a climbing support.

It is equally possible to arrange e.g. a crane, which can take over further transport work, above a holder, which serves the support of two belt bridges or of a rotary arm, on a further holder or on the support column itself.

1. A transport system for the transport of bulk goods comprising a transport belt for the conveying of the bulk goods to an unloading point, with a rotary arm being provided which is rotatable about a vertical axis of rotation and which transports bulk goods to its free end and unloads it there, wherein the rotary arm is supported at a holder which is or can be arranged at a stationary support column such that the axis of rotation of the rotary arm extends eccentrically to the support column, with the rotary arm advantageously being arranged next to the support column, viewed from above, in at least one rotational position.

2. A transport system in accordance with claim 1, wherein the rotary arm is arranged in a rotary union which is supported via a first rotating assembly on the holder and bears, via a second rotating assembly, an end of a belt bridge which transports the bulk goods to the rotary arm.

3. A transport system in accordance with claim 1, wherein the holder is or can be arranged at the support column such that the rotary arm is arranged higher than the upper end of the support column so that it can be rotated above the support column.

4. A transport system in accordance with claim 1, wherein the support column comprises a plurality of elements, so that the height of the support column can be increased by placing on further elements.

5. A transport system in accordance with claim 4, wherein at least one element can be placed onto the support column without dismantling the holder and/or the rotary arm.

6. A transport system in accordance with claim 1, comprising a second support column at which a second holder is arranged, wherein the holder bears the end of a first belt bridge and the end of a second belt bridge.

7. A transport system in accordance with claim 6, wherein the first belt bridge is arranged in a rotary union on the second holder so that the first belt bridge is rotatable about a vertical axis of rotation with respect to the second holder and/or to the second belt bridge.

8. A transport system in accordance with claim 6, wherein the second holder is of the same construction as the holder for the rotary arm.

9. A transport system in accordance with claim 1, further comprising a lifting apparatus for the lifting of the rotary arm and/or of the belt bridge.

10. A transport system in accordance with claim 9, wherein the lifting apparatus can be arranged at a support column, in particular at an element of the support column, which can be set on the upper end of the support column for this purpose.

11. A support column for a transport system for the transport of bulk goods for the support of at least one belt bridge and/or at least one rotary arm, wherein the support column comprises a holder for the belt bridge and/or for the rotary arm which is mounted to the support column so that the belt bridge and/or the rotary arm are arranged next to the support column, viewed from above, with the belt bridge and/or the rotary arm being arranged higher than the upper end of the support column and wherein the support column can be extended beyond the holder by a further element which can be mounted to the upper end of the support column.

12. A method for the rebuilding of a transport system for the transport of bulk goods comprising a belt bridge and/or a rotary arm having a transport belt for the conveying of the bulk goods, wherein the belt bridge and/or the rotary arm is arranged to the side next to the support column and wherein lifting of the belt bridge and/or of the rotary arm takes place via a lifting device arranged at the support column above the belt bridge and/or the rotary arm.

13. A method in accordance with claim 12, wherein at least one element for lifting of the belt bridge and/or the rotary arm is placed onto the support column to extend it beyond the holder and the lifting device is arranged at the element.

14. A method in accordance with claim 13, wherein the element is removed again after the rebuilding.

15. A method in accordance with claim 14, wherein, after the lifting of the belt bridge and/or of the rotary arm, a rotary union is mounted, dismantled and/or replaced and the belt bridge and/or the rotary arm is thereupon lowered again.

16. A transport system in accordance with claim 1, wherein the bulk goods are concrete.

17. A transport system in accordance with claim 4, wherein the elements are lattice elements.

18. A support column for a transport system for the transport of bulk goods according to claim 12, wherein the bulk goods are concrete.

19. A method for rebuilding a transport system in accordance with claim 12, wherein the bulk goods are concrete.

20. A method in accordance with claim 13, wherein the element is a lattice element.
